(19) United States
(12) Patent Application Publication
(10) Pub. No.: US 2012/0323638 A1
(43) Pub. Date: Dec. 20, 2012

(54) PRODUCTION SYSTEM CARRIER CAPACITY PREDICTION PROCESS AND TOOL

(75) Inventors: Ivory Wellman Knipfer, Rochester, MN (US); Carl Craig Meier, Rochester, MN (US); Dale William Petersilka, Eau Claire, WI (US); Matthew H. Zemke, Rochester, MN (US)

(73) Assignee: INTERNATIONAL BUSINESS MACHINES CORPORATION, Armonk, NY (US)

(21) Appl. No.: 13/163,673

(22) Filed: Jun. 18, 2011

(51) Int. Cl. G06Q 10/00

(52) U.S. Cl. 705/7.37

(57) ABSTRACT

A production system includes an information handling system (IHS) having a carrier capacity prediction tool that receives a customer order that may include packaging and carrier requirements. The carrier capacity prediction tool partitions the customer order into work units. The carrier capacity tool determines work unit carrier capacity requirements from historical data that a volumetric weight database stores. If the volumetric weight database does not include sufficient historical information to determine carrier capacity requirements, the carrier capacity tool predicts carrier capacity requirements from best fit or actual packaging data during final packaging of customer goods for shipment. The carrier capacity tool sums all work unit packaging and volumetric weight data for each customer order to generate an aggregate of the total carrier capacity needs for a particular time period for production system shipping.

### BACKGROUND

The disclosures herein relate generally to information handling systems (IHSs), and more specifically, to IHSs that manage production processes and that predict carrier capacity for shipping customer goods.

Production systems may employ information handling systems (IHSs) that execute applications or other processes that support production processes such as order fulfillment and supply chain management. Order fulfillment includes processing of customer orders, manufacturing, production and shipment of customer goods. Order fulfillment processing may include management of custom or configurable customer orders. Configurable customer orders or configure-to-order processes drive custom builds or build-to-order production processes. Carrier capacity may represent a significant expense during the order fulfillment or supply chain process.

### BRIEF SUMMARY

In one embodiment, a method for determining required carrier capacity is disclosed that includes receiving, by a carrier capacity prediction tool, a first order for configurable customer goods at a first order time. The method also includes determining at approximately the first order time, by the carrier capacity prediction tool, if the first order exhibits a first complexity level for which the carrier capacity prediction tool already includes sufficient order characteristic information and sufficient packaging history information to make a carrier capacity prediction for the configurable customer goods corresponding to the first order. Otherwise the carrier capacity prediction tool determines that the first order exhibits a second complexity level for which the carrier capacity prediction tool does not already have sufficient packaging history information and sufficient order characteristic information to make a carrier capacity prediction. The method also includes predicting at approximately the first order time, by the carrier capacity prediction tool, the carrier capacity in response to the determining that the first order exhibits the first complexity level. The method still further includes determining at time of packaging of the configurable customer goods, by the carrier capacity prediction tool, the carrier capacity in response to the determining that the first order exhibits the second complexity level.

In one embodiment, the method also includes partitioning at approximately the first order time, by the carrier capacity tool, the first order into a plurality of work units. The method further includes testing at approximately the first order time, by the carrier capacity prediction tool, the work units of the plurality of work units to determine respective complexity levels of the work units, each work unit exhibiting one of the first and second complexity levels. The method still further includes predicting at approximately the first order time, by the carrier capacity prediction tool, respective carrier capacities for those work units of the plurality of units that exhibit the first complexity level. The method also include determining at time of packaging of the configurable customer goods, by the carrier capacity prediction tool, the respective carrier capacities of those work units of the plurality of work units that exhibit the second complexity level. The method may still further include summing, by the carrier capacity prediction tool, the respective carrier capacities of the work units that exhibit the first complexity level with the respective carrier capacities of the work units that exhibit the second complexity level to determine the total carrier capacity required for the first order. The method also includes storing at the time of packaging, by the carrier capacity prediction tool, respective carrier capacities for work units that exhibit the second complexity level so that the carrier capacity tool learns the carrier capacities of work units not previously encountered by the carrier capacity tool before the first order time.

In another embodiment, an information handling system (IHS) is disclosed that includes a processor and a memory coupled to the processor. The memory is configured with a carrier capacity prediction tool that receives receive a first order for configurable customer goods at a first order time. The memory is also configured to determine at approximately the first order time if the first order exhibits a first complexity level for which the carrier capacity prediction tool already includes sufficient order characteristic information and sufficient packaging history information to make a carrier capacity prediction for the configurable customer goods corresponding to the first order, and otherwise determine that the first order exhibits a second complexity level for which the carrier capacity prediction tool does not already have sufficient packaging history information and sufficient order characteristic information to make a carrier capacity prediction. The memory is further configured to predict at approximately the first order time the carrier capacity in response to determining that the first order exhibits the first complexity level. The memory is also configured to determine at time of packaging of the configurable customer goods the carrier capacity in response to determining that the first order exhibits the second complexity level.

In yet another embodiment, a carrier capacity prediction tool computer program product is disclosed that includes a non-transitory computer readable storage medium. The computer program product includes first instructions that receive a first order for configurable customer goods at a first order time. The computer program product also includes second instructions that determine at approximately the first order time if the first order exhibits a first complexity level for which the carrier capacity prediction tool computer program product already includes sufficient order characteristic information and sufficient packaging history information to make a carrier capacity prediction for the configurable customer goods corresponding to the first order, and that otherwise determine that the first order exhibits a second complexity level for which the carrier capacity prediction tool computer program product, does not already have sufficient packaging history information and sufficient order characteristic information to make a carrier capacity prediction. The computer program product further includes third instructions that predict at approximately the first order time the carrier capacity in response to determining that the first order exhibits the first complexity level. The computer program product also includes fourth instructions that determine at time of packaging of the configurable customer goods the carrier capacity in response to determining that the first order exhibits the second complexity level. The first, second, third and fourth program instructions are stored on the non-transitory computer readable storage medium.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of a representative information handling system (IHS) that employs the disclosed carrier capacity prediction methodology.

FIG. 2 shows a block diagram of a production system that includes an IHS that employs the disclosed carrier capacity prediction methodology.

FIG. 3 shows a volumetric weight databases within an IHS that employs the disclosed carrier capacity prediction methodology.

FIG. 4 shows a detailed unique ID history database within the volumetric weight databases of an IHS that employs the disclosed carrier capacity prediction methodology.

FIG. 5 shows a packaging material projection database within the volumetric weight databases of an IHS that employs the disclosed carrier capacity prediction methodology.

FIG. 6 shows a detailed part information database within the volumetric weight databases of an IHS that employs the disclosed carrier capacity prediction methodology.

FIG. 7 shows an allowed packaging material database within the volumetric weight databases of an IHS that employs the disclosed carrier capacity prediction methodology.

FIG. 8A and FIG. 8B depict a flowchart of an embodiment of the disclosed carrier capacity prediction capability.

### DETAILED DESCRIPTION

Production systems may employ information handling systems (IHSs) that employ processes and tools to support production processes such as order fulfillment and supply chain management. Order fulfillment includes processing of custom or configurable customer orders as well as production and shipment of customer goods. Configurable customer orders or configure-to-order processes drive custom builds or build-to-order production processes within the production system. One critical process within the production system is the shipment or carrier planning process. An effective shipment process includes the prediction or estimate of future carrier capacity needs at the time of a customer order. Establishing carrier capacity early in the order fulfillment process allows the production system greater visibility and cost management of carrier costs and shipment scheduling. Effective prediction of volumetric weight characteristics for customer goods may provide the production system with improvements in customer order planning. The disclosed carrier capacity prediction tool may significantly improve customer goods shipping costs and production system efficiencies.

Improvements in carrier capacity predictions translate directly into reductions in overall production system costs as well as improvements in customer order shipment times. Production systems may employ the volumetric weight characteristics of particular customer goods when determining carrier capacity requirements. Volumetric weight is a combination of shipping volume and weight information of customer goods that common and contract carriers or shipping companies such as trucking firms use as a dimensional weight measure to determine carrier capacity. For example, a trucking firm may provide a truck that includes a maximum volume and a maximum weight load. The volumetric weight information for customer goods that a business entity may need to ship may provide the business entity with an effective way of determining how many trucks the customer goods require. In this scenario, the business entity is the producer of the customer goods or manufacturer.

In a configure-to-order environment, a producer's or manufacturer's production system may not know the volumetric weight for a customer order and corresponding manufactured customer goods at time of ordering. To complicate matters, configure-to-order customer goods often ship at different times. Determining or projecting carrier capacity needs at the time of packaging within the production system does not provide adequate time to effectively manage carrier capacity. This deficiency may result in the producer reserving too much or too little carrier capacity, thus resulting in late carrier adjustments that increase production system times as well as shipping costs. Poor carrier capacity planning may also result in missed shipping times. Poor carrier capacity planning may also cause shipping delays with the resultant loss of customer satisfaction.

Production systems may rely on fixed material definitions to determine projected volumetric weight characteristics of a customer order at the time of order. In a configure-to-order environment and particularly in a complex production build cycle, fixed material definitions such as bills of materials are dynamic and highly variable. Fixed material definitions may not provide enough detail to generate volumetric weight characteristics at the time of order and may lead to poor carrier capacity planning. In this case, production systems often rely on end-of-line or end-of packaging determination of carrier capacity needs that translates into poor timing for carrier capacity needs. Although this last minute calculation of carrier capacity may be highly accurate, the poor timing results in unused or missing carrier capacity. This unused carrier capacity leads to poor production efficiencies and increased shipping costs.

In one embodiment, the disclosed carrier capacity prediction method provides carrier capacity determination at the time of customer order. The method combines past shipment characteristics of identical or similar customer orders together with prediction capability of carrier costs for variable or configure-to-order customer orders. Shipment characteristics include volumetric weight characteristics that take into account packaging requirements for each customer order. By combining all production work units of a customer order and also combining all customer orders within the production system, one embodiment of the method provides an overall carrier capacity shipping estimate for a predetermined period of time.

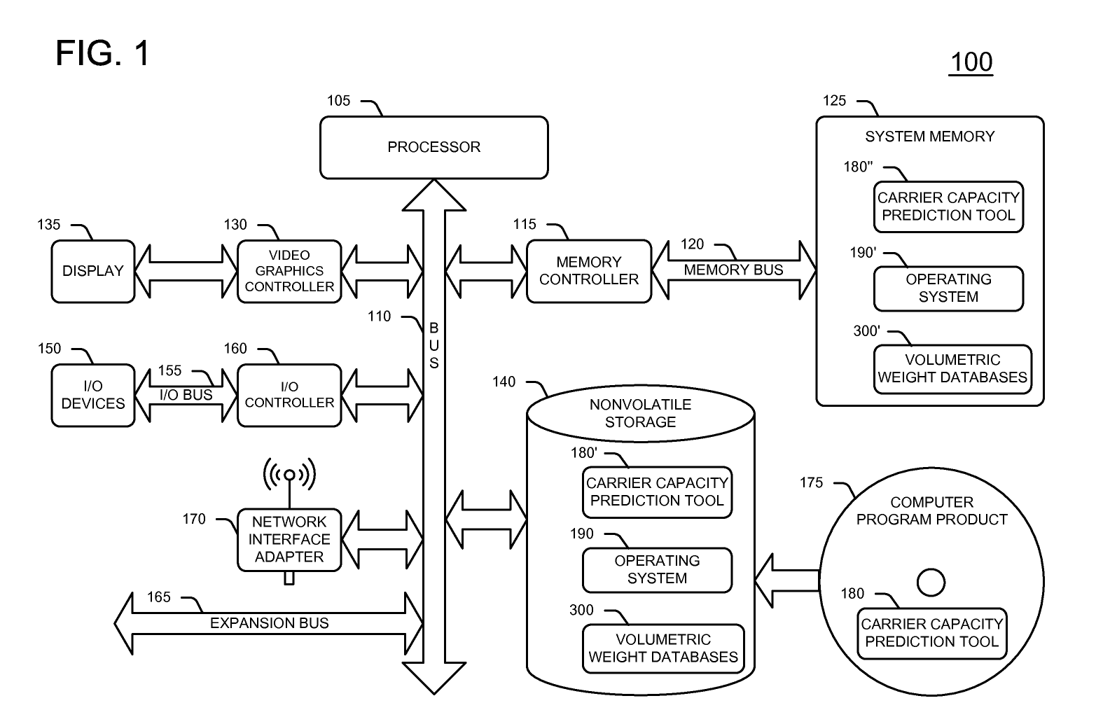

FIG. 1 shows an information handling system (IHS) 100 with a carrier capacity prediction tool 180 and a volumetric weight databases 300 that employs the disclosed carrier capacity prediction methodology. Volumetric weight databases 300 may include multiple data structures that store carrier capacity information in the form of customer goods production system attributes and other information. Order fulfillment IHS 100 includes a processor 105. In one embodiment, processor 105 may include multiple processors cores (not shown). Order fulfillment IHS 100 processes, transfers, communicates, modifies, stores or otherwise handles information in digital form, analog form or other form. Order fulfillment IHS 100 includes a bus 110 that couples processor 105 to system memory 125 via a memory controller 115 and memory bus 120. In one embodiment, system memory 125 is external to processor 105. System memory 125 may be a static random access memory (SRAM) array or a dynamic random access memory (DRAM) array.

Processor 105 may also include local memory (not shown) such as L1 and L2 caches (not shown). A video graphics controller 130 couples a display 135 to bus 110. Nonvolatile storage 140, such as a hard disk drive, CD drive, DVD drive, or other nonvolatile storage couples to bus 110 to provide order fulfillment IHS 100 with permanent storage of information. I/O devices 150, such as a keyboard and a mouse pointing device, couple to bus 110 via I/O controller 160 and I/O bus 155.

One or more expansion busses 165, such as USB, IEEE 1394 bus, ATA, SATA, PCI, PCIE, DVI, HDMI and other busses, couple to bus 110 to facilitate the connection of peripherals and devices to the order fulfillment IHS 100. A network interface adapter 170 couples to bus 110 to enable order fulfillment IHS 100 to connect by wire or wirelessly to a network and other information handling systems. Network interface adapter 170 may also be called a network communication adapter or a network adapter. While FIG. 1 shows one IHS that employs processor 105, the IHS may take many forms. For example, order fulfillment IHS 100 may take the form of a desktop, server, portable, laptop, notebook, netbook, tablet or other form factor computer or data processing system. order fulfillment IHS 100 may take other form factors such as a gaming device, a personal digital assistant (PDA), a portable telephone device, a communication device or other devices that include a processor and memory.

Order fulfillment IHS 100 employs an operating system (OS) 190 that may store information on nonvolatile storage 140. order fulfillment IHS 100 includes a computer program product on digital media 175 such as a CD, DVD or other media. In one embodiment, a user or other entity configures the computer program product with carrier capacity prediction tool 180 software to practice the disclosed carrier capacity prediction methodology. In practice, order fulfillment IHS 100 may store carrier capacity prediction tool 180 and volumetric weight databases 300 on nonvolatile storage 140 as carrier capacity prediction tool 180′ and volumetric weight databases 300, respectively. Nonvolatile storage 140 may also store OS 190. In one embodiment, not shown, OS 190 may include carrier capacity prediction tool 180.

When order fulfillment IHS 100 initializes, the IHS loads carrier capacity prediction tool 180′, OS 190, and volumetric weight databases 300 into system memory 125 for execution as carrier capacity prediction tool 180″, OS 190′, and volumetric weight databases 300′, respectively. During execution of carrier capacity prediction tool 180, order fulfillment IHS 100 may employ volumetric weight databases 300 to store customer order production information, as described in more detail below. In accordance with the disclosed methodology, carrier capacity prediction tool 180 may employ volumetric weight databases 300 as well as other memory resources of order fulfillment IHS 100 to maintain customer order production information during the order fulfillment process that includes ordering and shipping of customer goods.

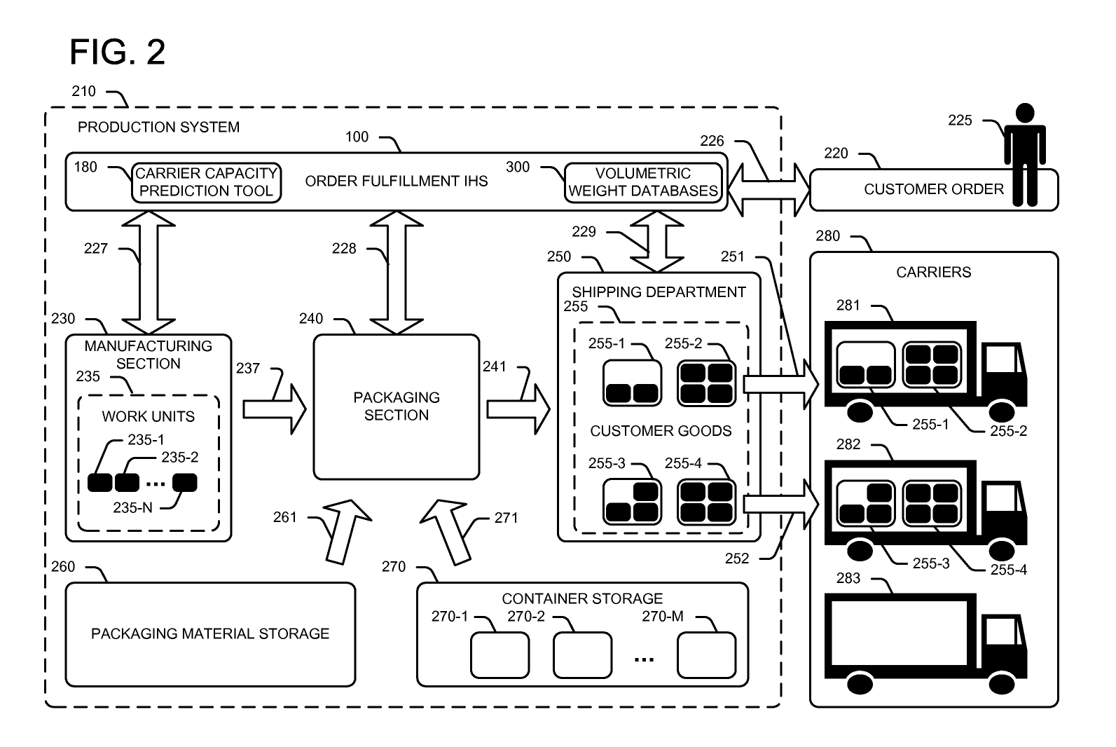

FIG. 2 depicts a production system 210 that provides customer order fulfillment and employs the disclosed carrier capacity prediction capability. Production system 210 provides manufacturing and customer order fulfillment. Production system 210 receives customer order 220 from customer 225. In response to the customer order 220, production system 210 predicts the carrier capacity needed to ship the customer goods associated with the customer orders. Using the predicted carrier capacity, production system 210 communicates with carriers 280 to order an appropriate number of shipping vehicles, with an appropriate volume and weight capability, to ship the ordered goods.

In more detail, production system 210 includes order fulfillment IHS 100 that employs carrier capacity prediction tool 180 and volumetric weight databases 300, as shown in FIG. 1, to practice the disclosed methodology. As shown by a bidirectional arrow 227, order fulfillment IHS 100 communicates with a customer 225. Arrow 226 may represent a wire link, wireless link or other communication link that customer 225 may employ to communicate a customer order 220 to production system 210. The customer order 220 that customer 225 sends to production system 210 may include custom configure-to-order information. For example, customer order 220 may include a customizable configuration of goods, delivery date requirements, special carrier needs and other order information.

As shown by bidirectional arrows 227, 228 and 229, order fulfillment IHS 100 couples to and communicates with a manufacturing section 230, a packaging section 240, and a shipping department 250, respectively. In actual practice, order fulfillment IHS 100 couples to and communicates with respective IHSs (not shown) in manufacturing section 230, packaging section 240, and shipping department 250. Manufacturing section 230 may include work units 235, such as work units 235-1, 235-2, . . . 235-N, wherein N represents the total number of work units within work units 235 for customer order 220. Unidirectional arrows indicate the direction of work or work unit flow within production system 210.

Work units 235 may include small piece parts or assemblies, such as keyboards, mice, spare parts, or other small work unit assemblies. Work units 235 may include larger assemblies such as server racks, cooling units, or other assemblies that may include multiple assemblies within themselves. Work units 235 may include one or more work units to form larger and more complex work units during manufacturing section 230 operations. Work units 235 may each exhibit unique volumetric weight characteristics as discussed in more detail below. In more detail, work units may exhibit different sizes, weights, dimensions and volumes.

In one embodiment, production system 210 partitions customer order 220 into units of work, namely work units 235, such as work units 235-1, 235-2, . . . 235-N, wherein N represents the total number of work units within work units 235 for customer order 220. In this manner, carrier capacity prediction tool 180 may identify characteristics for each work unit that apply to carrier capacity determination. For example, work unit 235-1 may require special packaging for overnight delivery, work unit 235-2 may require special packaging for clean room requirements. In one embodiment, carrier capacity prediction tool 180 may identify carrier capacity needs for multiple work units and combine those results to determine a total carrier capacity need for a particular grouping of work units, such as those shown in manufacturing section 230 as work units 235.

Work units 235 may combine together or separate into smaller assemblies during packaging in packaging section 240. The collection of all work units 235 for customer order 220 defines the customer goods, such as customer goods 255. Carrier capacity prediction tool 180 in order fulfillment IHS 100 may determine those work units 235 that require shipment to a particular customer 225 during a particular period of time and determine carrier needs during that time period.

As shown by a unidirectional arrow 237, production system 210 exhibits a flow of activity or work from manufacturing section 230 into packaging section 240. The work flow of production system 210 includes the flow of packaging materials from a packaging material storage 260 to packaging section 240 as shown by unidirectional arrow 261. Production system 210 provides flow of containers from container storage 270 into packaging section 240 as indicated by unidirectional arrow 271. Packaging materials in packaging material storage 260 may include standard packaging materials or custom packaging materials that the customer order 220 specifies. More particularly, packaging materials may include materials such as injection or custom fit foam packaging, shock absorbing material, temperature protection, material finish protection lining or covers, and other packaging materials. Production system 210 may employ packaging section 240 to combine customer order 220 as work units 235 with packaging material 260 prior to shipping customer order 220 as customer goods 255 to customer 225.

Shipping container storage 270 may include multiple containers, such as containers 270-1, 270-2, . . . 270-M, wherein M represents the total number of containers for customer goods 255 in container storage 270. Containers may be crates, boxes, or other forms of containment that carriers employ to properly ship production system 210 goods or assemblies. Production system 210 resources, such as assembly personnel, or machines assemble containers 270, packaging material 260 and manufacturing 230 work units 235 content within packaging 240. At this time work units 235, such as work units 235-1, 235-2, . . . 235-N, wherein N represents the total number of work units within work units 235 for customer order 220, may combine into larger assemblies or be split into smaller assemblies. For example, production system 210 resources may combine or split work units 235 during final assembly in manufacturing 230, or during final packaging within packaging 240.

Production system 210 includes a shipping department 250 that ships finished, manufactured customer goods 255 via carriers 280. As shown by a unidirectional arrow 241, production system 210 provides work flow from packaging section 240 to shipping department 250. Customer goods 255 may include multiple containers that each include multiple work units, such as those of work units 235. For example, as shown in FIG. 2, container 255-1 includes two work units, such as those of work units 235-1, 235-2, . . . 235-N, wherein N represents the total number of work units within work units 235 for a particular customer order 220. In this example, container 255-2 includes four work units, container 255-3 includes three work units and container 255-4 includes four work units to complete the customer goods 255 that customer order 220 specifies. The containers may include and store a different number of work units than FIG. 2 illustrates.

In one embodiment, customer goods 255 may include containers 270-1, 270-2, . . . 270-M, wherein M represents the total number of containers for customer goods 255. Customer goods 255 may also include packaging material 260, as well as work units 235-1, 235-2, . . . 235-N, wherein N represents the total number of work units from customer order 220. Unidirectional arrows 251 and 252 show the direction of flow of customer goods 255 from shipping department 250 within production system 210 to carriers 280. Carriers 280 includes carriers such as ground transportation vehicles, air transportation vehicles, water transportation vehicles and or other modes of transportation from production system 210 to customer 225. In one example shown in FIG. 2, carriers 280 include multiple shipping trucks, namely truck 281, truck 282 and truck 283.

During a particular time period, such as an end-of-day delivery time, truck 281 may contain customer goods 255-1 and customer goods 255-2. Truck 282 may contain customer goods 255-3 and customer goods 255-4. As shown in FIG. 2, truck 283 is empty and production system 210 only requires truck 281 and truck 282 to complete a particular customer order 220 and to deliver the corresponding customer goods 255 to customer 225. In one embodiment, carrier capacity prediction tool 180 determines that production system 210 does not require truck 283 for customer goods 255 in advance and releases or otherwise removes truck 283 requirements from carriers 280 for this particular time period. In this manner, carrier capacity prediction tool 180 provides accurate carrier vehicle counts, such as truck counts, to production system 210. As described in more detail below, carrier capacity prediction tool 180 eliminates the problem wherein a production facility reserves an excess number of carrier vehicles or too few carrier vehicles for a particular order or combination of multiple orders.

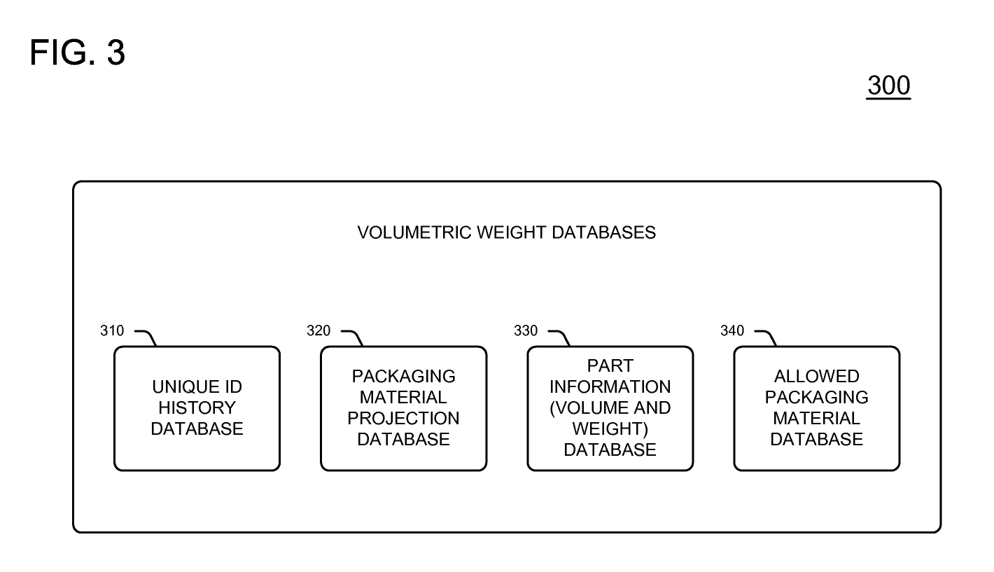

FIG. 3 is a block diagram of volumetric weight databases 300 that carrier capacity prediction tool 180 populates with volumetric weight information during production system 210 processing of previous customer orders 225 and/or the current customer order 220. Carrier capacity prediction tool 180 may employ a memory block or portion of system memory 125 as volumetric weight databases 300. In one embodiment of the disclosed carrier capacity prediction tool 180, volumetric weight databases 300 includes customer order information in the form of multiple memory data structures or databases 310, 320, 330 and 340. Volumetric weight databases 300 may include multiple memory locations or cells that store volumetric weight information in these databases. Carrier capacity prediction tool 180 may map the information within volumetric weight databases 300 to point to or link that information by customer ID or other pointer. In other embodiments of the disclosed method, volumetric weight databases 300 may provide non-linked information that carrier capacity prediction tool 180 interprets with other memory methods.

For example, volumetric weight databases 300 includes customer order 220 information in unique ID history database 310. A unique identifier or ID may associate with each historical customer order. Unique ID history database 310 may provide production system 210 with information that describes a particular previous customer order 220, such as bills of materials, previous ID history or other identifying information for customer order 220.

Volumetric weight databases 300 also includes packaging material projection database 320. Packaging material projection database 320 provides production system 210 with packaging material estimates from previous identical orders or previous similar orders. Previous identical orders are defined as previous orders for goods identical to the goods of the current order. Similar orders are defined as previous orders for goods not identical to, but similar to, the goods of the current order. Packaging material projection database 320 may provide useful information as to what type of packaging material pertains to a particular current customer order 220. For example, packaging material projection database 320 may provide quantity, volume, and weight characteristics for packaging material that pertains to customer order 220.

Volumetric weight databases 300 includes part information database 330 that may include volume and weight information. Part information database 330 provides carrier capacity prediction tool 180 with information pertaining to particular part number volume and weight information. Part information database 330 may provide carrier capacity prediction tool 180 with volume and weight information that carrier capacity prediction tool 180 may accumulate to generate a portion of total volume and weight information for customer order 220, and more particularly for customer goods 255.

Volumetric weight databases 300 also includes an allowed packaging material database 340 that provides production system 210 and carrier capacity prediction tool 180 with packaging type information for customer order 220. In some cases, special packaging requirements are part of customer order 220. For example, the customer goods 255 may ship to clean rooms, or ship in special carriers, or other special circumstances. These situations may call for particular types of allowed packaging materials. Allowed packaging material type database 340 provides carrier capacity prediction tool 180 with useful packaging information for further analysis of volumetric weight characteristics for customer order 220 and respective particular customer goods 255.

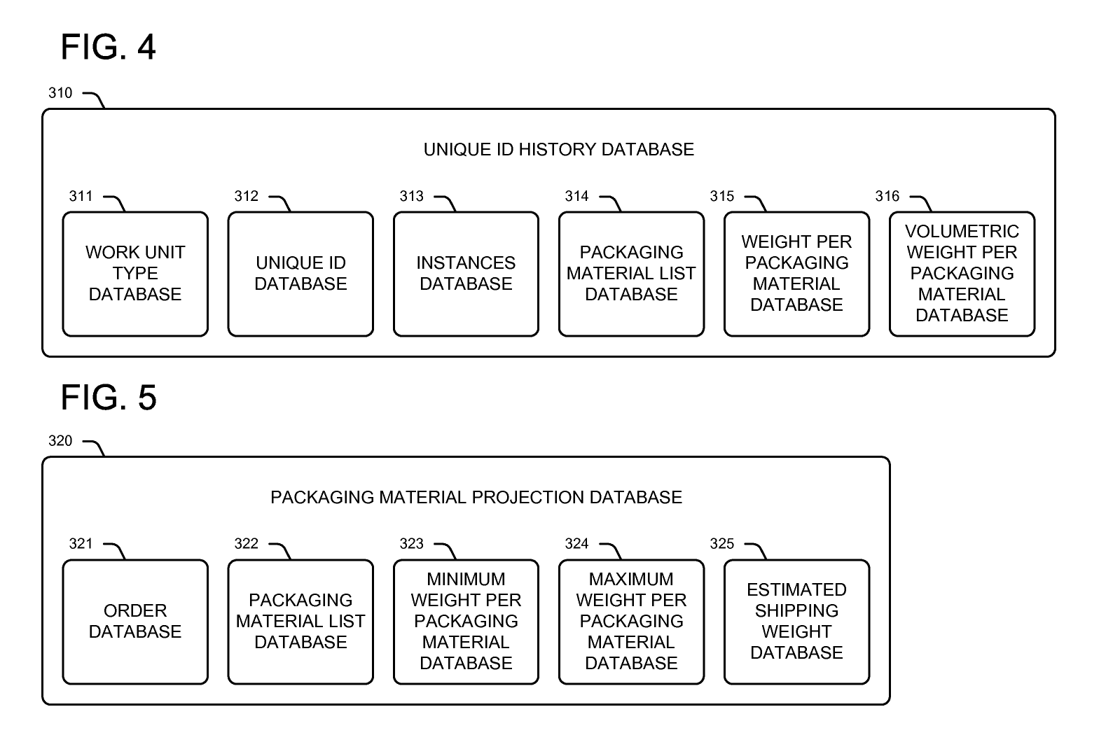

FIG. 4 is a block diagram that provides more detail with respect to unique ID history database 310 of volumetric weight databases 300. Unique ID history database 310 stores work unit type information 311 that may include work unit 235 information that pertains to a particular previous customer order 220 ID or identifier. For example, the work unit 235 type may refer to a modular assembly, piece part assembly, or other work unit 235 type. Unique ID history database 310 also includes unique ID database 312 as part of volumetric weight databases 300. The unique ID database 312 may include identification history, such as past identification numbers for all or part of previous customer order 220.

Unique ID history database 310 includes instances database 313 that may provide carrier capacity prediction tool 180 with past uses for any particular customer order, such as customer order 220. Unique ID history database 310 includes packaging material list database 314. Packaging material list database 314 may provide carrier capacity prediction tool 180 with previous or historical packaging material information that pertains to a previous customer order 220. Unique ID history database 310 includes weight per packaging material database 315. Weight per packaging material database 315 may provide carrier capacity prediction tool 180 with historical packaging material weight information that pertains to a previous customer order 220.

Unique ID history database 310 includes volumetric weight per packaging material database 316. Volumetric weight per packaging material database 316 may provide carrier capacity prediction tool 180 with historical packaging volumetric weight information that pertains to previous customer order 220. Carrier capacity prediction tool 180 may employ ID history database 310 during determination of carrier capacity volumetric weight and other predictions for customer order 220 in accordance with the disclosed method. Carrier capacity prediction tool 180 may also employ volumetric weight databases 300 to store historical information relating to a previous customer order 220 and customer goods 255 as unique ID history database 310 information. In actual practice, volumetric weight databases 300 may store this information for multiple previous customer orders 220 or all previous customer orders 220.

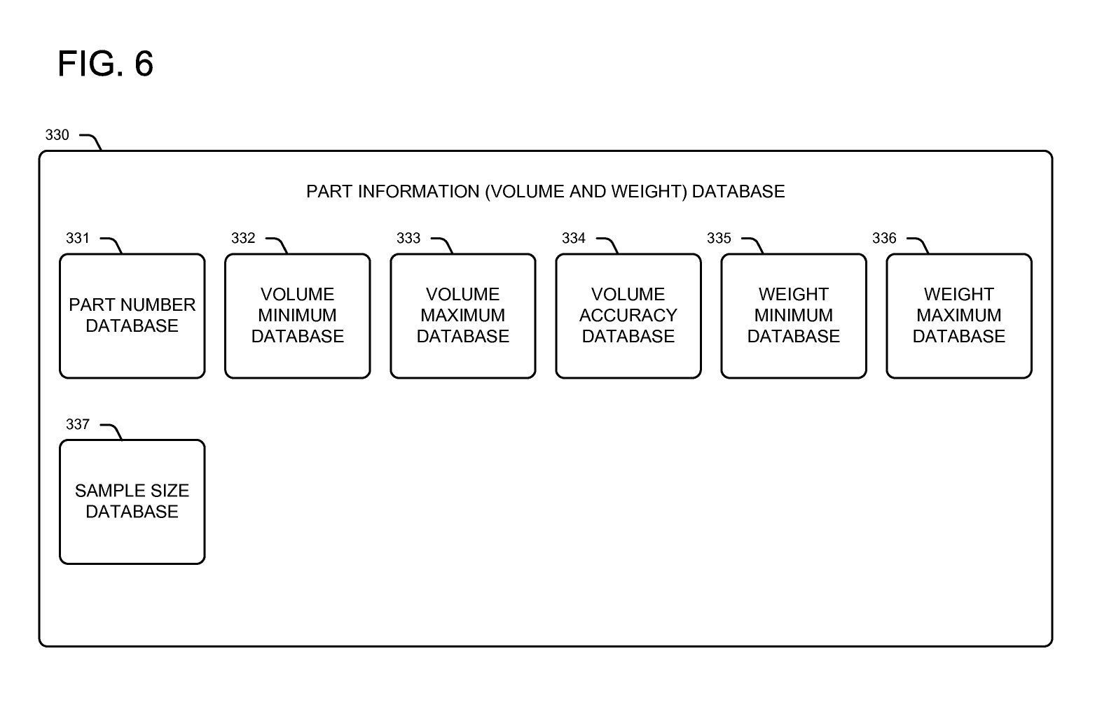

FIG. 5 is a block diagram that provides more detail with respect to packaging material projection database 320 of volumetric weight databases 300. Packaging material projection database 320 includes an order database 321 that may include customer order 220 detailed information, such as schedule, cost or other order information. Packaging material projection database 320 includes a packaging material list database 322 as part of volumetric weight databases 300. Packaging material list database 322 may include packaging material information for use within packaging 240 for customer order 220. Carrier capacity prediction tool 180 may employ packaging material list database 322 to identify information useful for the formation of volumetric weight data and carrier capacity predictions for customer goods 255.

Packaging material projection database 320 includes a minimum weight per packaging material database 323. Minimum weight per packaging material database 323 may provide carrier capacity prediction tool 180 with weight information for different packaging materials for use by the disclosed carrier capacity prediction methodology. Packaging material projection database 320 also includes a maximum weight per packaging material database 315. Maximum weight per packaging material database 324 together with minimum weight per packaging material database 323 provide carrier capacity prediction tool 180 with packaging weight boundary or limit information in reference to customer goods 255.

Packaging material projection database 320 includes an estimated shipping weight database 325. Estimated shipping weight provides carrier capacity prediction tool 180 with early estimate information for customer goods 255 prior to shipping by shipping department 250. Carrier capacity prediction tool 180 may employ the information within packaging material projection database 320 during determination of carrier capacity volumetric weight and other predictions for customer order 220 in accordance with the disclosed method. Carrier capacity prediction tool 180 may also employ volumetric weight databases 300 to store historical information for customer order 220 and customer goods 255 as packaging material projection database 320 information.

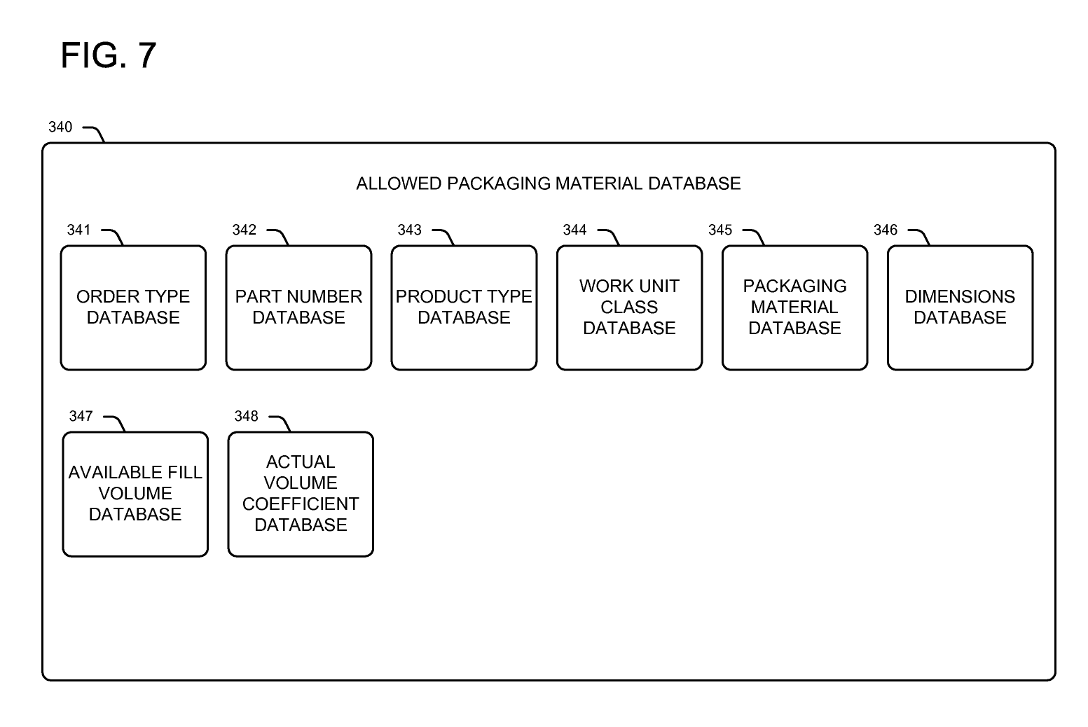

FIG. 6 is a block diagram that provides more detail with respect to part information database 330 of volumetric weight databases 300. Part information database 330, that includes volume and weight information, further includes a part number database 331. Part number database 331 may include detailed part number information for customer order 220. Part number database 331 may also include detailed part number information for previous customer orders, such as customer order 220. Part information database 330 includes a volume minimum database 332 and volume maximum database 333. Volume minimum database 332 and volume maximum database 333 provide volume boundaries, i.e. volume limits, for customer goods 255. In one embodiment, the information within part information database 330 corresponds to a particular work unit of customer order 220. Carrier capacity prediction tool 180 may compile or otherwise accumulate individual work units 235 of customer order 220 to generate a complete customer goods 255 determination of volumetric weight as well as other information.

Part information database 330 may include volume accuracy database 334 to provide accuracy dimensions for the volumetric weight determination of customer goods 255 by carrier capacity prediction tool 180. Part information database 330 includes a weight minimum database 335 and weight maximum database 336. In one embodiment, weight minimum database 335 includes historical minimum weight information for parts that work units 235 may use during manufacturing to produce work unit assemblies, such as work units 235-1, 235-2, . . . 235-N, wherein N represents the total number of work units within work units 235 for customer order 220. Similarly, weight maximum database 336 includes historical maximum weight information for parts that work units 235 may use during manufacturing to produce work unit assemblies, such as work units 235-1, 235-2, . . . 235-N.

In other words, each piece part within work units 235 may include a weight between minimum and maximum weight values within weight minimum database 335 and weight maximum database 336 respectively. Carrier capacity prediction tool 180 may employ the information within weight minimum database 335 and weight maximum database 336 to determine boundaries for weight information that pertains to work units 235 and ultimately customer goods 255. In this manner, carrier capacity prediction tool 180 may determine minimum and maximum weight predictions for production system 210 finished goods, such as customer goods 255.

Part information database 330 includes sample size database 337 that carrier capacity prediction tool 180 may employ to determine units for volume and weight measures, such as ounces, pounds, cubic feet or other such measures. Carrier capacity prediction tool 180 may employ the information within part information database 330 to determine carrier capacity volumetric weight and other predictions for customer order 220 in accordance with the disclosed method. Carrier capacity prediction tool 180 may also employ volumetric weight databases 300 to store historical information with respect to customer order 220 and customer goods 255 in part information database 330.

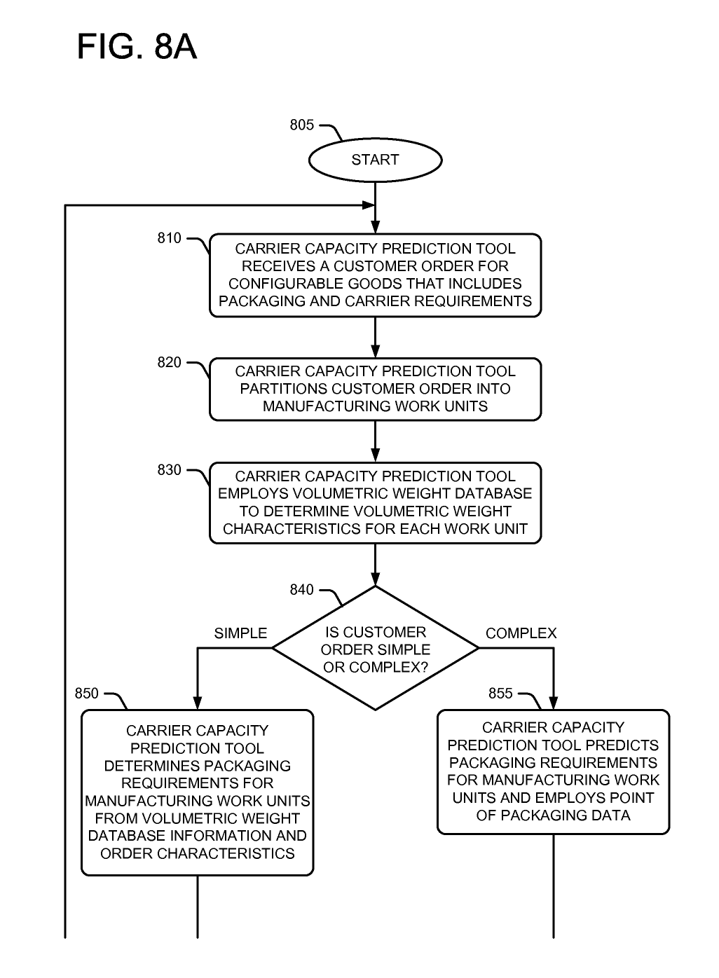

FIG. 7 is a block diagram that provides more details of allowed packaging material database 340 of volumetric weight databases 300. Allowed packaging material database 340 includes an order type database 341. Order type database 341 may include detailed customer order information for customer order 220, such as new order, retrofit order, spare parts order, or other order type information. Allowed packaging material database 340 includes a part number database 342. Part number database 342 may provide carrier capacity prediction tool 180 with useful part information for current customer order 220 and subsequent customer goods 255. For example, part number database 342 may store each particular part number that personnel or other resources of production system 210 include within work units 235 to generate customer goods 255. Each part number may provide links into other memory locations and information within volumetric weight databases 300.

Allowed packaging material database 340 includes a product type database 343. Product type database 343 may provide carrier capacity prediction tool 180 with particular product category information for customer goods 255. Allowed packaging material database 340 includes a work unit class database 344. Work unit class database 344 may provide carrier capacity prediction tool 180 with particular work unit information, such as work units 235-1, 235-2, . . . 235-N, wherein N represents the total number of work units within work units 235 for customer order 220.

Allowed packaging material database 340 includes a packaging material database 345 that stores packaging material information describing the different types of packaging material available to production system 210 in the past and currently. Carrier capacity prediction tool 180 may employ the packaging material information in packaging material database 345 to determine packaging requirements for work units 235 of customer order 220 for which production system 210 produces the ordered customer goods 255. Allowed packaging material database 340 includes a dimensions database 346 that stores dimensional information that carrier capacity prediction tool 180 employs to determine volumetric information pertaining to packaging material for a particular work unit 235 of customer goods 255. For example, dimensions database 346 may include sizes for packaging material such as form fitting packaging or other material that packaging section 240 employs during packaging of customer goods 255.

Allowed packaging material database 340 includes an available fill volume database 347 and actual volume coefficient database 348. Available fill volume database 347 stores information so that carrier capacity prediction tool 180 may determine how much volume for particular customer goods 255 includes fill materials, such as foam padding or shipping peanuts. Actual volume coefficient database 348 stores information such as how much space within customer goods 255 corresponds to parts and how much space corresponds to either packaging material or empty space. For example, customer goods 255 may include work units such as servers parts, and may also include packaging materials such as bubble wrap. Customer goods 255 may also include empty space that carrier capacity prediction tool 180 takes into account to determine the total volume for customer goods 255.

In other words, carrier capacity prediction tool 180 may employ the information within available fill volume database 347 and actual volume coefficient database 348 to determine volume characteristics of customer goods 255. Carrier capacity prediction tool 180 may employ the information within allowed packaging material database 340 as well as within all of volumetric weight databases 300 during determination of carrier capacity volumetric weight and other predictions for customer order 220 in accordance with the disclosed method. Carrier capacity prediction tool 180 may also employ volumetric weight databases 300 to store historical information associated with customer order 220 and customer goods 255 as allowed packaging material database 340 information.

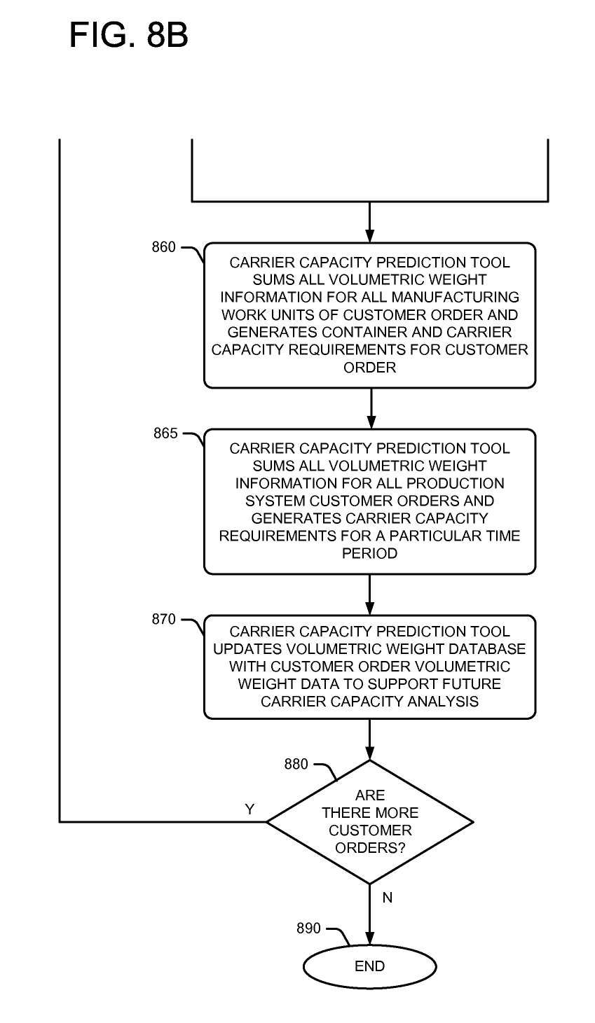

FIG. 8A and FIG. 8B depict a flowchart of process flow in one embodiment of the disclosed carrier capacity prediction methodology. More specifically, the flowchart of FIG. 8A and FIG. 8B shows how the carrier capacity prediction tool 180 provides production system 210 with early determination of carrier requirements for shipping customer goods. This early determination of carrier requirements enables production system 210 to communicate to carriers the correct number of shipping vehicles needed to ship the customer goods corresponding to a particular order or group of orders with the same or similar destination. This communication may occur far in advance of the actual time of shipment. Production system 210 may reduce shipping costs by accurately reserving the correct number of transportaiton vehicles of appropriate capacity in advance of the time of shipment,

In more detail, carrier capacity prediction tool 180 employs volumetric weight databases 300 and other production system 210 resources to provide real time carrier capacity predictions for a customer order. In other words, carrier capacity production tool 180 provides carrier capacity predictions at the time of customer order 220 submission to the producer, or shortly after the time of customer order 220 submission. Carrier capacity predictions provide information to shipping department 250 that enables shipping department 250 to accurately schedule or reserve the correct number of transportation vehicles from carriers 280 to ship customer goods 255.

The disclosed carrier capacity prediction method starts, as per block 805. Carrier capacity prediction tool 180 receives a customer order 220 for configurable goods that includes packaging and carrier requirements, as per block 810. If customer order 220 does not explicitly define packaging and carrier requirements, those requirements may be retrievable from predefined or historic customer data that production system 210 stores. Production system 210 may be a highly configurable or variable order system. In that case, production system 210 may provide configure-to-order capability and require highly variable and configurable capability from packaging section 240 and carriers 280 during the processing of customer order 220 and customer goods 255.

Carrier capacity prediction tool 180 may employ information from resources of production system 210 to determine carrier capacity constraints. For example, carrier capacity prediction tool 180 may take into account available packaging within packaging material storage 260 as well as other data from production system 210 in determination of carrier capacity requirements for a particular customer order 220.

Carrier capacity prediction tool 180 partitions customer order 220 into manufacturing work units, as per block 820. Examples of such work units may include server racks, server monitors, keyboards, other work unit assemblies. More particularly, within manufacturing 230, carrier capacity prediction tool 180 may partition customer order 220 into particular work units that are selected from work units 235-1, 235-2, . . . 235-N and that are appropriate for a particular customer order 220. The sum of all selected works units 235 defines the total customer order 220. Later, in the production process, the selected work units 235 may combine into larger assemblies or break down into smaller assemblies within manufacturing section 230 or during final packaging by packaging section 240 to form customer goods 255. Manufacturing section 230 may build some of work units 235 at different times. In other words, manufacturing section 230 need not assemble or manufacture each work unit at the same time.

Carrier capacity prediction tool 180 employs volumetric weight databases 300 to determine volumetric weight characteristics for each work unit, as per block 830. For example, carrier capacity prediction tool 180 may interpret data within volumetric weight databases 300 to determine the volumetric weight characteristics for each of the work units selected from work units 235-1, 235-2, . . . 235-N for customer order 220. Carrier capacity prediction tool 180 determines and provides predicted packaging requirements for each work unit or work unit assembly within manufacturing section 230. In some cases, particular work units within work unit 235 may not require any packaging or need for containers 270. In one embodiment, carrier capacity prediction tool 180 performs a test to determine if a current customer order is a “simple” customer order or a “complex” customer order, as per block 840. A current customer order is a customer order that production system 210 receives and is currently processing.

A simple customer order 220 is a case wherein volumetric weight databases 300 already includes adequate or sufficient representative or historical volumetric weight information for that customer order. A complex customer order 220 is a case wherein volumetric weight databases 300 does not include sufficient representative or historical volumetric weight information for that customer order. In the case of complex customer orders, carrier capacity prediction tool 180 may require predictive analysis of current customer order 220 to determine best volumetric weight information, as described below.

If customer order 220 is simple, then carrier capacity prediction tool 180 determines packaging requirements for manufacturing 230 work units from volumetric weight databases 300 information and order characteristics, as per block 850. For example, one or more work units 235-1, 235-2, . . . 235-N for customer order 220 correspond to historical packaging information within volumetric weight database 300. In this case, carrier capacity prediction tool 180 may interrogate volumetric weight databases 300 to determine the packaging requirements for those work units of customer order 220 and ultimately the packaging requirements for the corresponding customer goods 255.

Volumetric weight databases 300 may maintain order characteristic information that includes part number ID or part characteristics information. Volumetric weight databases 300 may also maintain packaging history information that includes previous customer order packaging information. Carrier capacity prediction tool 180 may employ order characteristic information and packaging history information to determine if customer order 220 is simple. In one embodiment, carrier capacity prediction tool 180 generates work unit 235 volumetric weight information by combining the work unit 235 volume and weight data within the packaging volume and weight data of packaging section 240.

However, if customer order 220 is complex, then carrier capacity prediction tool 180 predicts packaging requirements for manufacturing section 230 work units 235 and employs point of packaging data, as per block 855. For example, carrier capacity prediction tool 180 may use some historical information as a basis to predict packaging requirements for one or more work units 235-1, 235-2, . . . 235-N for corresponding to customer order 220. In one embodiment, carrier capacity prediction tool 180 interprets similar work unit historical data from volumetric weight databases 300 to determine particular work units 235 packaging requirements.

In the case wherein customer order 220 is complex, carrier capacity prediction tool 180 may determine some packaging requirements for work units 235 at the time of order. Carrier capacity prediction tool 180 may determine packaging requirements from historical information of previous or past orders of same or similar customer goods. Carrier capacity prediction tool 180 may determine remaining packaging requirements at packaging time for any remaining work units. In the complex order case, production system 210 learns and trains itself by storing customer order volumetric weight information that production system 210 determines at packaging time. In particular, in complex orders production system 210 may not discovery all volumetric weight information for those work units from previous order history at order time.

Carrier capacity prediction tool 180 may utilize other techniques, processes, or calculations for work unit packaging requirement analysis or prediction. Carrier capacity prediction tool 180 also employs actual volumetric weight information from packaging section 240. Carrier capacity prediction tool 180 may learn or otherwise write as data stores into volumetric weight databases 300 for actual manufacturing 230 work unit packaging data. Carrier capacity prediction tool 180 may use this information within volumetric weight databases 300 for future work unit packaging requirement analysis. By learning in this manner, carrier capacity prediction tool 180 may dramatically improve early customer order 220 work unit packaging requirement analysis efforts in the future.

Carrier capacity prediction tool 180 sums all volumetric weight information for all manufacturing work units of customer order 220 and generates container and carrier capacity requirements for customer order 220, as per block 860. In other words, carrier capacity prediction tool 180 combines all volumetric weight information that includes packaging information for all selected manufacturing work units 235 corresponding to or needed for a partcular current customer order 220. From volumetric weight information that corresponds to the selected manufacturing units 235, carrier capacity prediction tool 180 determines container and carrier capacity requirements for corresponding containers, such as those of containers 270-1, 270-2, . . . 270-M, wherein M represents the total number of containers for customer goods 255 and carriers 280. In one embodiment, carrier capacity prediction tool 180 combines the volumetric weight data for multiple customer orders to generate an aggregate or total carrier capacity need for a given time period for multiple or all customer orders within production system 210.

Carrier capacity prediction tool 180 sums all volumetric weight information for all production system 210 customer orders and generates carrier capacity requirements for a particular period of time, as per block 865. In other words, carrier capacity prediction tool 180 may determine that multiple customer orders, such as those similar to customer order 220 will complete production and be ready to ship at the same point in time. At this point of time, such as an end-of-day shipping period, carrier capacity prediction tool 180 may determine all carrier capacity requirements in total for all or multiple customer orders. In this manner, carrier capacity prediction tool 180 may determine the total number of carriers that shipping department 250 requires for that point in time.

Carrier capacity prediction tool 180 updates volumetric weight databases 300 with customer order 220 volumetric weight data to support future carrier capacity analysis, as per block 870. In other words, after carrier capacity prediction tool 180 generates carrier capacity requirements for customer order 220, carrier capacity prediction tool 180 populates volumetric weight databases 300 with volumetric weight information that pertains to actual customer order 220 packaging 240 and shipping 250. In that manner, if a future customer order 220 arrives at production system 210, carrier capacity prediction tool 180 may more quickly determine customer order 220 carrier capacity requirements from historical information within volumetric weight database 300. Carrier capacity prediction tool 180 also keeps volumetric weight databases 300 up to date with the latest packaging requirements by monitoring any last minute packaging change information within packaging section 240 and updating volumetric weight databases 300 accordingly.

Carrier capacity prediction tool 180 performs a test to determine if there are more customer orders, as per block 880. If more customer orders remain for processing, flow continues back to per block 710 and the process begins again. In this manner, multiple customer order volumetric weight calculations are possible within a predefined period of time. Carrier capacity prediction tool 180 may sum or aggregate the total volumetric weight and other order and shipment requirements for multiple orders. Carrier capacity prediction tool 180 may use this summation of volumetric weight information to determine best fit of carrier capacity for production system 210 during any particular shipping period. For example, one particular shipping period may be end-of-day shipments into trucks or other carriers 280. If there are no more customer orders, the disclosed methodology ends, as per block 890.

As will be appreciated by one skilled in the art, aspects of the disclosed application optimizer methodology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the FIG. 8A and FIG. 8B flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart of FIG. 8A and FIG. 8B and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart of FIG. 8A and FIG. 8B described above.

The flowcharts of FIG. 8A and FIG. 8B illustrates the architecture, functionality, and operation of possible implementations of systems, methods and computer program products that perform network analysis in accordance with various embodiments of the present invention. In this regard, each block in the flowcharts of FIG. 8A and FIG. 8B may represent a module, segment, or portion of code, which comprises one or more executable instructions for implementing the specified logical function(s). It should also be noted that, in some alternative implementations, the functions noted in the block may occur out of the order noted in FIG. 8A and FIG. 8B. For example, two blocks shown in succession may, in fact, be executed substantially concurrently, or the blocks may sometimes be executed in the reverse order, depending upon the functionality involved. It will also be noted that each block of FIG. 8A and FIG. 8B and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method, comprising:
receiving, by a carrier capacity prediction tool, a first order for configurable customer goods at a first order time;
determining at approximately the first order time, by the carrier capacity prediction tool, if the first order exhibits a first complexity level for which the carrier capacity prediction tool already includes sufficient order characteristic information and sufficient packaging history information to make a carrier capacity prediction for the configurable customer goods corresponding to the first order, and otherwise determining that the first order exhibits a second complexity level for which the carrier capacity prediction tool does not already have sufficient packaging history information and sufficient order characteristic information to make a carrier capacity prediction;
predicting at approximately the first order time, by the carrier capacity prediction tool, the carrier capacity in response to the determining that the first order exhibits the first complexity level; and
determining at time of packaging of the configurable customer goods, by the carrier capacity prediction tool, the carrier capacity in response to the determining that the first order exhibits the second complexity level.

2. The method of claim 1, further comprising:
partitioning at approximately the first order time, by the carrier capacity tool, the first order into a plurality of work units;
testing at approximately the first order time, by the carrier capacity prediction tool, the work units of the plurality of work units to determine respective complexity levels of the work units, each work unit exhibiting one of the first and second complexity levels;
predicting at approximately the first order time, by the carrier capacity prediction tool, respective carrier capacities for those work units of the plurality of units that exhibit the first complexity level; and
determining at time of packaging of the configurable customer goods, by the carrier capacity prediction tool, the respective carrier capacities of those work units of the plurality of work units that exhibit the second complexity level.

3. The method of claim 2, further comprising:
summing, by the carrier capacity prediction tool, the respective carrier capacities of the work units that exhibit the first complexity level with the respective carrier capacities of the work units that exhibit the second complexity level to determine the total carrier capacity required for the first order.

4. The method of claim 1, further comprising:
storing at the time of packaging, by the carrier capacity prediction tool, respective carrier capacities for work units that exhibit the second complexity level so that the carrier capacity tool learns the carrier capacities of work units not previously encountered by the carrier capacity tool before the first order time.

5. The method of claim 2, further comprising:
receiving, by the carrier capacity prediction tool, a second order for configurable customer goods at a second order time;
partitioning at approximately the second order time, by the carrier capacity tool, the second order into a plurality of work units;
determining, by the carrier capacity prediction tool, the respective carrier capacities of the work units associated with the second order; and
combining, by the carrier capacity prediction tool, carrier capacities associated with the work units of the first and second orders to determine a total carrier capacity for the first and second orders.

6. The method of claim 5, further comprising:
combining, by the carrier capacity prediction tool, carrier capacities associated with the work units of the first and second orders and other orders processed by the carrier capacity tool over a predetermined time period to determine total carrier capacity needed to transport the first, second and other orders.

7. The method of claim 1, wherein the determining at approximately the first order time and the predicting at approximately the first order time occur in real time.

8. The method of claim 1, further comprising:
storing, by the carrier capacity prediction tool, respective carrier capacities of work units in a volumetric weight database.

9. An information handling system (IHS), comprising:
a processor;
a memory coupled to the processor, the memory being configured with a carrier capacity prediction tool to:
receive a first order for configurable customer goods at a first order time;
determine at approximately the first order time if the first order exhibits a first complexity level for which the carrier capacity prediction tool already includes sufficient order characteristic information and sufficient packaging history information to make a carrier capacity prediction for the configurable customer goods corresponding to the first order, and otherwise determine that the first order exhibits a second complexity level for which the carrier capacity prediction tool does not already have sufficient packaging history information and sufficient order characteristic information to make a carrier capacity prediction;
predict at approximately the first order time the carrier capacity in response to determining that the first order exhibits the first complexity level; and
determine at time of packaging of the configurable customer goods the carrier capacity in response to determining that the first order exhibits the second complexity level.

10. The IHS of claim 9, wherein the memory is further configured to:
partition at approximately the first order time, by the carrier capacity tool, the first order into a plurality of work units;
test at approximately the first order time the work units of the plurality of work units to determine respective complexity levels of the work units, each work unit exhibiting one of the first and second complexity levels;
predict at approximately the first order time respective carrier capacities for those work units of the plurality of units that exhibit the first complexity level; and
determine at time of packaging of the configurable customer goods the respective carrier capacities of those work units of the plurality of work units that exhibit the second complexity level.

11. The IHS of claim 10, wherein the memory is further configured to:
sum the respective carrier capacities of the work units that exhibit the first complexity level with the respective carrier capacities of the work units that exhibit the second complexity level to determine the total carrier capacity required for the first order.

12. The IHS of claim 9, wherein the memory is further configured to:
store respective carrier capacities for work units that exhibit the second complexity level so that the carrier capacity tool learns the carrier capacities of work units not previously encountered by the carrier capacity tool before the first order time.

13. The IHS of claim 10, wherein the memory is further configured to:
receive a second order for configurable customer goods at a second order time;
partition at approximately the second order time the second order into a plurality of work units;
determine the respective carrier capacities of the work units associated with the second order; and
combine the carrier capacities associated with the work units of the first and second orders to determine a total carrier capacity for the first and second orders.

14. The IHS of claim 13, wherein the memory is further configured to:
combine carrier capacities associated with the work units of the first and second orders and other orders processed by the carrier capacity tool over a predetermined time period to determine total carrier capacity needed to transport the first, second and other orders.

15. The IHS of claim 9, wherein carrier capacity prediction tool determines in real time if the first order exhibits the first complexity level and wherein the carrier capacity prediction tool predicts in real time the carrier capacity in response to determining that the first order exhibits the first complexity level.

16. The IHS of claim 9, further comprising a volumetric database in which the carrier capacity prediction tool stores respective carrier capacities of work units.

17. A carrier capacity prediction tool computer program product, comprising:
a non-transitory computer readable storage medium;
first instructions that receive a first order for configurable customer goods at a first order time;
second instructions that determine at approximately the first order time if the first order exhibits a first complexity level for which the carrier capacity prediction tool computer program product already includes sufficient order characteristic information and sufficient packaging history information to make a carrier capacity prediction for the configurable customer goods corresponding to the first order, and that otherwise determine that the first order exhibits a second complexity level for which the carrier capacity prediction tool computer program product, does not already have sufficient packaging history information and sufficient order characteristic information to make a carrier capacity prediction;
third instructions that predict at approximately the first order time the carrier capacity in response to determining that the first order exhibits the first complexity level;
fourth instructions that determine at time of packaging of the configurable customer goods the carrier capacity in response to determining that the first order exhibits the second complexity level;
wherein the first, second, third and fourth program instructions are stored on the non-transitory computer readable storage medium.

18. The carrier capacity prediction tool computer program product of claim 16, further comprising:
fifth instructions that partition at approximately the first order time the first order into a plurality of work units;
sixth instructions that test at approximately the first order time the work units of the plurality of work units to determine respective complexity levels of the work units, each work unit exhibiting one of the first and second complexity levels;
seventh instructions that predict at approximately the first order time respective carrier capacities for those work units of the plurality of units that exhibit the first complexity level; and
eighth instructions that determine at time of packaging of the configurable customer goods the respective carrier capacities of those work units of the plurality of work units that exhibit the second complexity level.

19. The carrier capacity prediction tool computer program product of claim 18, further comprising:
ninth instructions that sum the respective carrier capacities of the work units that exhibit the first complexity level with the respective carrier capacities of the work units that exhibit the second complexity level to determine the total carrier capacity required for the first order.

20. The carrier capacity prediction tool computer program product of claim 17, further comprising:
tenth instructions that store respective carrier capacities for work units that exhibit the second complexity level so that the carrier capacity prediction tool computer program product learns the carrier capacities of work units not previously encountered by the carrier capacity prediction tool computer program product before the first order time.
